(19) United States
(12) Patent Application Publication
(10) Pub. No.: US 2011/0040219 A1
(43) Pub. Date: Feb. 17, 2011

(54) Spinal Awareness, Massage, and Alignment Apparatus

(76) Inventors: Benjamin Tanner, Manheim, PA (US); Jeffrey B. Heilman, Lebanon, PA (US)

Correspondence Address: Law Offices of Michael Crilly, 104 South York Road, Hatboro, PA, 19040, US

(21) Appl. No.: 12/542,031

(22) Filed: Aug. 17, 2009

(51) Int. Cl. A61H 15/00

(52) U.S. Cl. 601/128

(57) ABSTRACT

An apparatus for massaging and aligning a spine is presented. The apparatus includes a base element, a pair of roller assemblies, a center roller assembly, a pair of hand bars, and a seat. The base element supports the apparatus along a surface. Each roller assembly includes an extendable arm and a plurality of rollers. The extendable arm is attached at one end to the base element so as to allow angular adjustment to the roller assembly with respect to the base element. The extendable arm is attached at a second end to the rollers so as to allow angular adjustment of the rollers with respect to the extendable arm. The center roller assembly is disposed between the roller assemblies and includes a second extendable arm and a pair of contoured rollers. The second extendable arm is attached at one end to the base element and at another end to the contoured rollers. The hand bars are attached to the second extendable arm and slide thereon so as to adjust the height of said bars. The seat is disposed at one end of the apparatus. The roller assemblies, center roller assembly, and hand bars are adjustable in height and angle so as to control the height, orientation, and relative position of the roller assemblies.

### CROSS REFERENCE TO RELATED APPLICATIONS

None.

### FEDERALLY SPONSORED RESEARCH AND DEVELOPMENT

None.

### BACKGROUND OF THE INVENTION

1. Field of the Invention

The invention generally relates to a hygiene apparatus with applicability to the human spinal column. Specifically, the invention includes a pair of roller assemblies disposed about a center roller assembly and a pair of hand bars which are attached to a base element so that the roller assemblies, center roller assembly, and hand bars are adjustable in height and angle so as to control the height and orientation of the roller assemblies.

2. Background

A variety of massage devices are provided for in the related arts.

For example, Hudock, U.S. patent application Ser. No. 11/340,134, describes an exercise surface formed by pairs of spherical elements arranged along a longitudinal axis. The spheres are dimensioned so as to protrude up into the areas near the facet joints along both sides of the spinal column and massage the supportive muscle and ligament tissue that supports the posterior spine. The spherical elements may be freely rotating spheres mounted in a frame or partial spherical elements molded into a base material.

In another example, Lindquist, U.S. Pat. No. 5,772,614, describes a back massage and exercise device comprising a substantially flat, elongate frame. A roller array, including a parallel series of elongate rollers, is loosely mounted in a spaced relationship between the long sides of the frame. The frame has an operative position in which a lower portion of substantially all of the rollers is in contact with the supporting surface, with an upper portion of the rollers being available for directly supporting the body of a user.

In yet another example, Gerschwender, U.S. Pat. No. 5,573,485, describes an exercise apparatus that manipulates the back in a manner intended to strengthen back muscles and maintain spine flexibility. Adjacent arrays of rollers are mounted on a frame in a manner that allows the arrays of rollers to be secured in a first position relative to one another, wherein adjacent pairs of rollers are coaxially aligned, and in a second position relative to one another, wherein adjacent pairs of rollers are out of alignment.

Accordingly, the related arts do not include a single apparatus that allows a user to greatly vary the height and angle of two or more rollers so as to optimize the point of focus or benefits of a roller-based massage and alignment device.

Therefore, what is required is an apparatus which is adjustable for a variety of body sizes and enables a user to adjust the height, angular orientation, and relative position of roller assemblies so as to invert, massage, and align the user's spinal column.

### SUMMARY OF THE INVENTION

An object of the present invention is to provide an apparatus which is adjustable for a variety of body sizes and enables a user to adjust the height, angular orientation, and relative position of roller assemblies so as to draw awareness to, invert, massage, and align the user's spinal column.

In accordance with embodiments of the invention, the apparatus includes a base element, a pair of roller assemblies, a center roller assembly, a pair of hand bars, and a seat. The base element supports the apparatus along a support surface and is substantially linear in construction. Each roller assembly includes an extendable arm and a plurality of rollers. The extendable arm is attached at one end to the base element so as to allow for angular adjustment to the roller assembly with respect to the base element. The extendable arm is attached at a second end to the rollers so as to allow angular adjustment of the rollers with respect to the extendable arm. The center roller assembly is disposed between the roller assemblies and includes a second extendable arm and a pair of contoured rollers. The second extendable arm is attached at one end to the base element and at another end to the contoured rollers. The hand bars are attached to the second extendable arm and slide thereon so as to adjust the height of the bars. The seat is disposed at one end of the apparatus.

The apparatus is a spinal self care device with virtually infinite positions to accommodate any body size. Its purpose is to allow the user to be become spinally self-aware of movement, fixation, and sensation. Stimulation is provided to spinal joints, ligaments, discs, musculature, and/or central and peripheral nerve systems.

The primary means to accomplish this is a contoured pair of rollers that apply a balanced point of contact along each side of the spine over the transverse process of the vertebrae. This leveraged action, with greater or lesser extension of the entire spine, provides enough pressure to release fixated spinal joints similar to a chiropractic adjustment and draws attention/awareness of the user to the spine.

The configuration and use of the apparatus is completely under control of the user for the greatest desired comfort and stimulation. The user's own body weight contributes to the self-correction. The specific center contoured rollers are mounted between two sets of paired rollers configured in an arc. The additional rollers not only support the spine but also stimulate the angle of the ribs near their attachment to the spine, to stimulate that joint as well. The user can control the amount of extension and support through manipulation of the elevation of the additional rollers and in so doing influence the diameter of the arc. The center contoured rollers could adjust in height at one-half inch increments for greater or lesser pressure directing more attention and awareness to a specific focal point thereby promoting greater intentional release, healing and strengthening throughout the entire spine or where the user feels the most need.

Several benefits are noteworthy. The invention promotes kinesthetic stimulation, stimulates proprioceptive nerve endings, could influence 6-10 joints per vertebra, mitigates the propensity towards injury and degenerative processes, restores biomechanical integrity, and strengthens inter/intra-vertebral fibrous attachments effecting overall strength of core musculature.

### REFERENCE NUMERALS

| | |
|---|---|
| 1 | Apparatus |
| 2 | Base element |
| 3 | Seat |
| 4 | Hand bar |
| 5 | Roller assembly |
| 6 | Center roller assembly |
| 7 | Hand bar |
| 8 | Vertical member |
| 9 | Horizontal member |
| 10 | Stabilizer arm |
| 11 | Center element |
| 12 | Outer tube |
| 13 | Bolt |
| 14 | Adjustment hole |
| 15 | Plate |
| 16 | Quick release pin |
| 17 | Cavity |
| 18 | Plate |
| 19 | U-shaped bar |
| 20 | Grip |
| 21 | Plate |
| 22 | Fastener |
| 23 | Bolt |
| 24 | Adjustable bolt |
| 25 | Knob |
| 26 | Inner tube |
| 27 | Quick release pin |
| 28 | Flange |
| 29 | Contoured roller |
| 30 | Padding |
| 31 | Washer |
| 32 | Bolt |
| 33 | Shaft |
| 34 | Low-friction washer |
| 35 | Bushing |
| 36 | Flange |
| 37 | Hole |
| 38 | Center plate |
| 39 | Hole |
| 40 | Plate |
| 41 | Bushing |
| 42 | Bolt |
| 43 | Roller |
| 46 | Slot |
| 47 | Bolt |
| 48 | Shaft |
| 49 | Bushing |
| 50 | Stop |
| 51 | Padding |
| 52 | Bolt |
| 53 | Washer |
| 54 | Extendable arm |
| 55 | Second extendable arm |
| 57 | L-shaped bar |
| 58 | Grip |
| 59 | Bolt |
| 60 | User |
| 61 | Flange |
| 62 | Threaded hole |
| 63 | Adjustable non-swivel guide |
| 65 | Fill |
| 66 | Planar element |
| 67 | Cover |
| 68 | Wall |
| 69 | Support surface |

### BRIEF DESCRIPTION OF THE INVENTION

Additional aspects, features, and advantages of the invention will be understood and will become more readily apparent when the invention is considered in the light of the following description made in conjunction with the accompanying drawings.

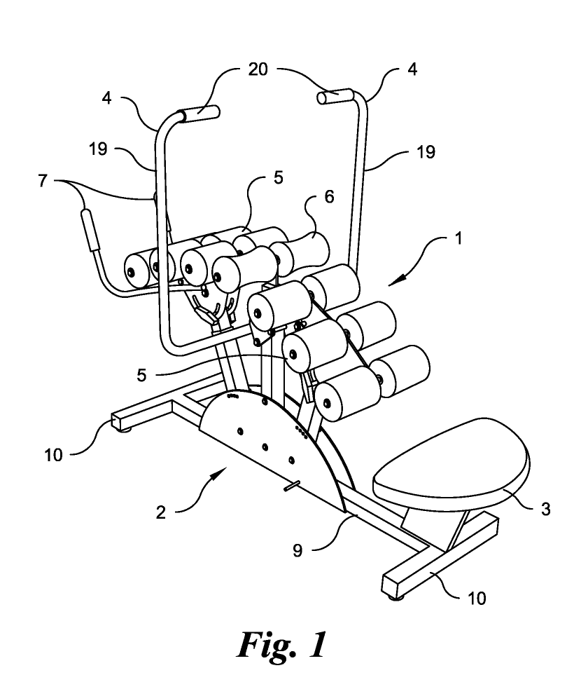

FIG. 1 is a perspective of the apparatus illustrating arrangement of a seat, a first roller assembly, a center roller assembly, a first pair of hand bars, a second roller assembly, and an optional second pair of hand bars disposed along and extending from a base element in accordance with an embodiment of the invention.

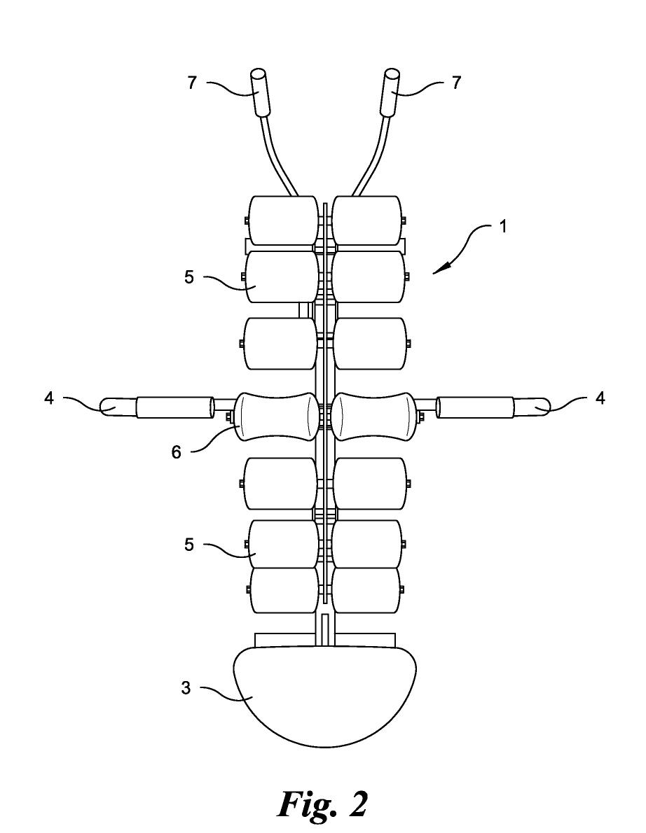

FIG. 2 is a top view of the apparatus shown in FIG. 1 further illustrating arrangement of a seat, a first roller assembly, a center roller assembly, a first pair of hand bars, a second roller assembly, and an optional second pair of hand bars disposed along and extending from a base element in accordance with an embodiment of the invention.

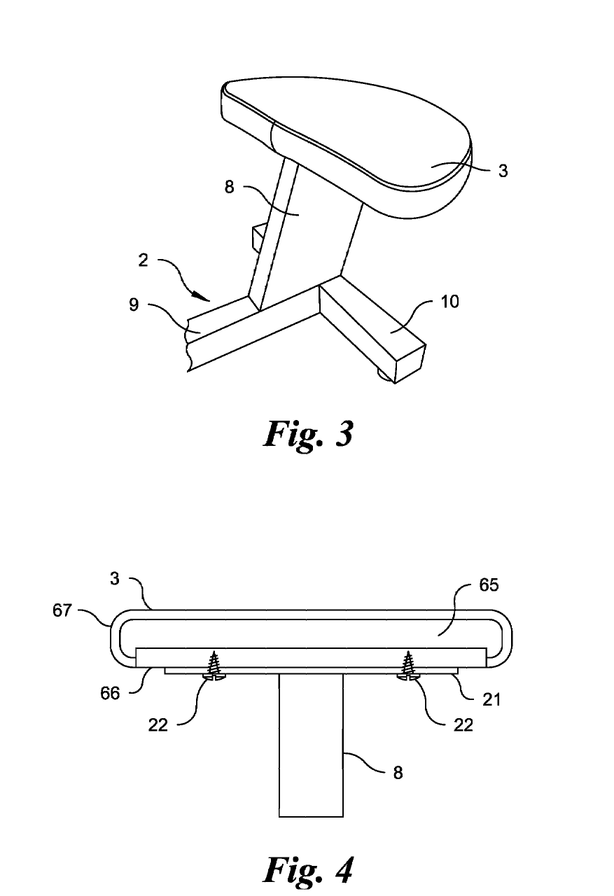

FIG. 3 is a perspective view of one end of the apparatus illustrating the arrangement of the seat with respect to the base element in accordance with an embodiment of the invention.

FIG. 4 is a cross-sectional view of the seat shown in FIG. 3 illustrating attachment of the seat to a plate attached to a vertical member extending from the base element in accordance with an embodiment of the invention.

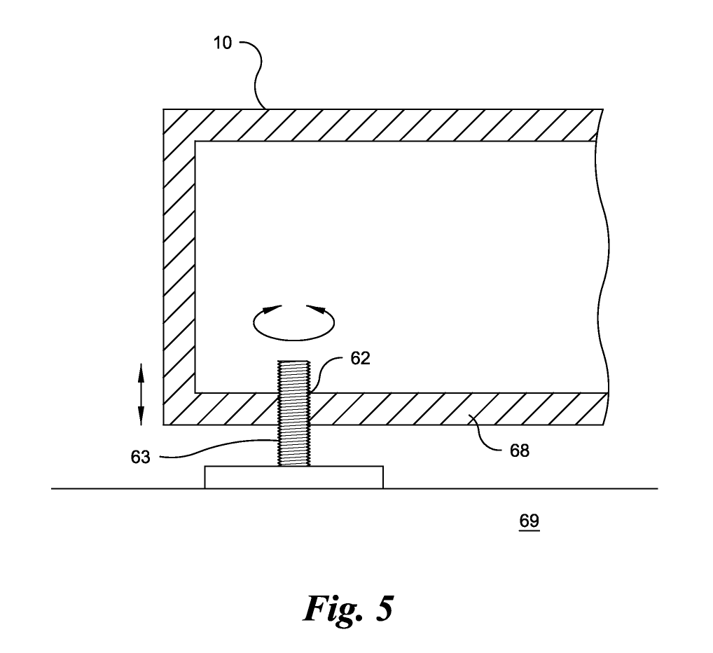

FIG. 5 is a cross-sectional view of one stabilizer arm along the base element illustrating attachment of an adjustable, non-swivel guide along one side of the stabilizer arm facilitating height adjustability for the apparatus with respect to a support surface in accordance with an embodiment of the invention.

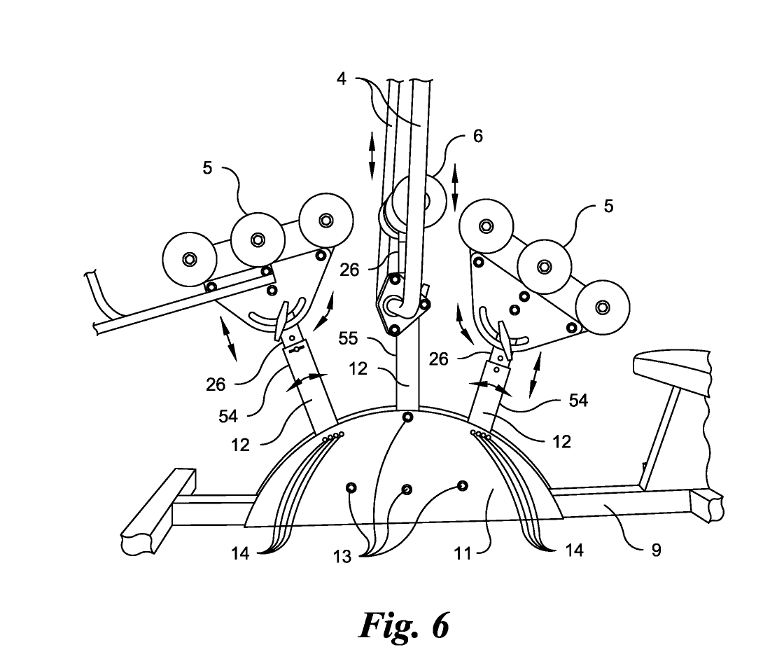

FIG. 6 is a side view of the apparatus illustrating attachment of the roller assemblies, center roller assembly, and hand bars to the base element and adjustability of the assemblies and bars with respect to the base element and one another in accordance with an embodiment of the invention.

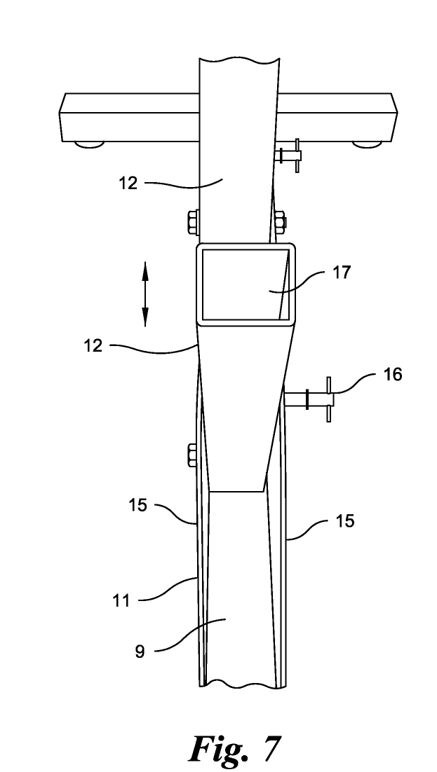

FIG. 7 is an enlarged view of an outer tube from a roller assembly with inner tube removed illustrating arrangement of the outer tube between a pair of plates attached to a horizontal member along the base element and attachment of the outer tube to the plates via a bolts so as to allow rotation of the outer tube in accordance with an embodiment of the invention.

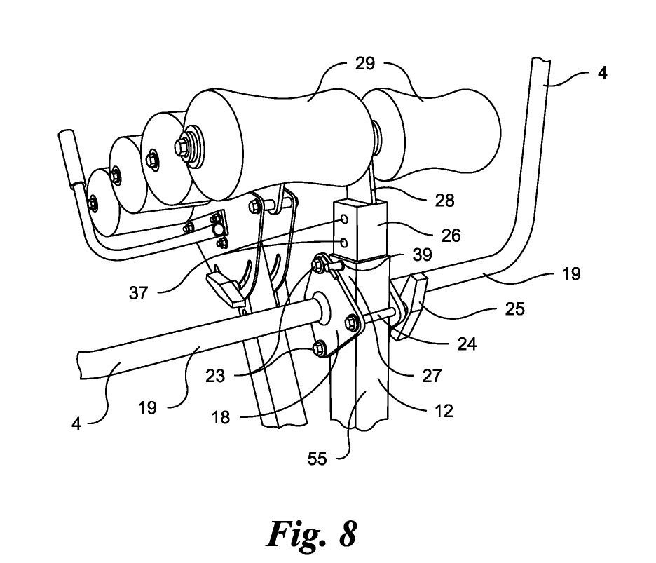

FIG. 8 is an enlarged perspective view of the center roller assembly and a portion of the hand bars illustrating attachment to the base element and adjustability with respect to the inner and outer tubes in accordance with an embodiment of the invention.

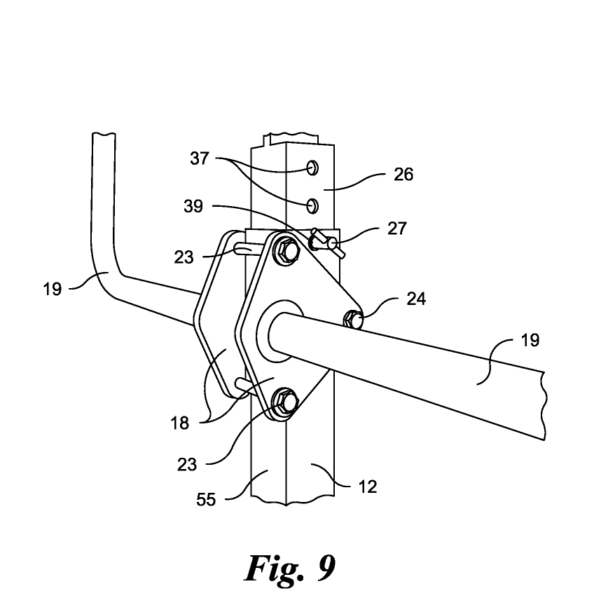

FIG. 9 is an enlarged perspective view of the hand bars illustrating an adjustable attachment of the hand bars with respect to the outer tube in accordance with an embodiment of the invention.

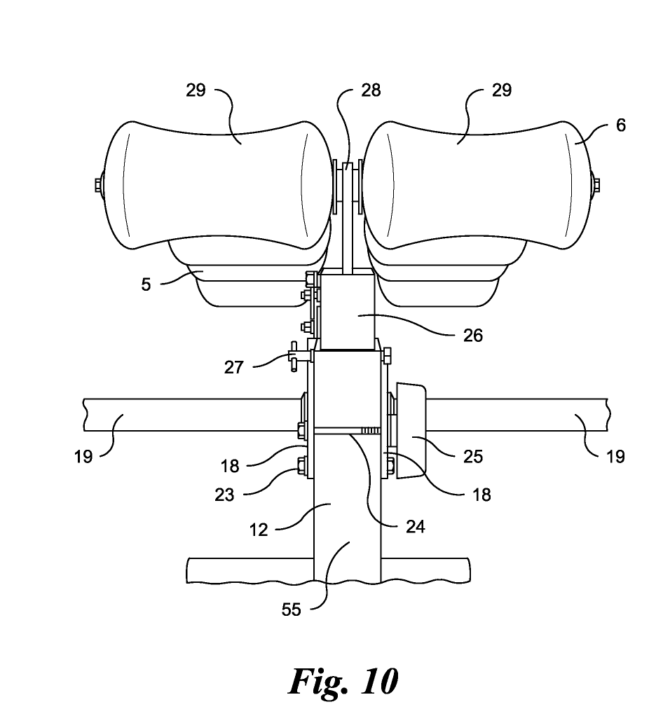

FIG. 10 is an enlarged frontal view of the center roller assembly and hand bars illustrating adjustable attachment thereof with respect to the outer tube in accordance with an embodiment of the invention.

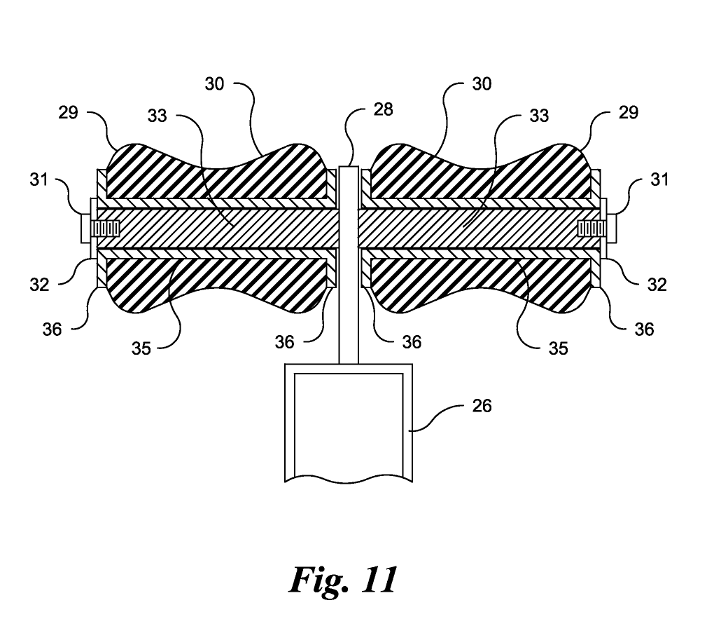

FIG. 11 is cross-sectional view of the center roller assembly illustrating attachment of the rollers to a central shaft in accordance with an embodiment of the invention.

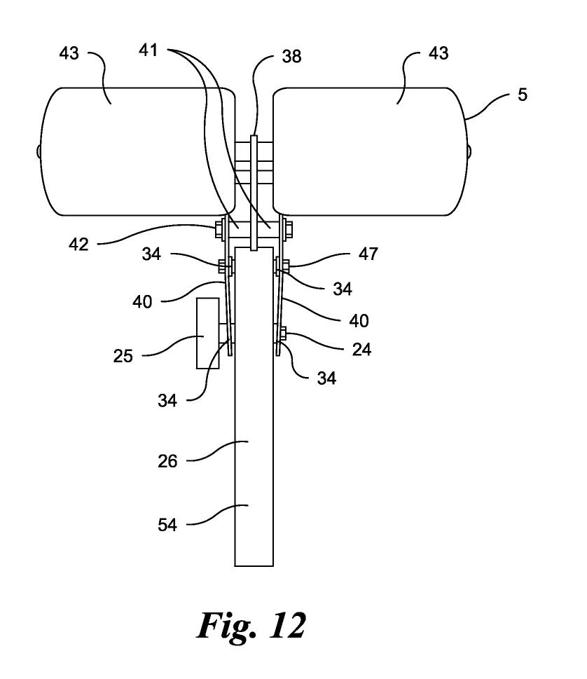

FIG. 12 is a frontal view of a roller assembly illustrating attachment of the rollers to a flange disposed between a pair of plates which are attached to an inner tube in an adjustable angular arrangement with respect to the rollers in accordance with an embodiment of the invention.

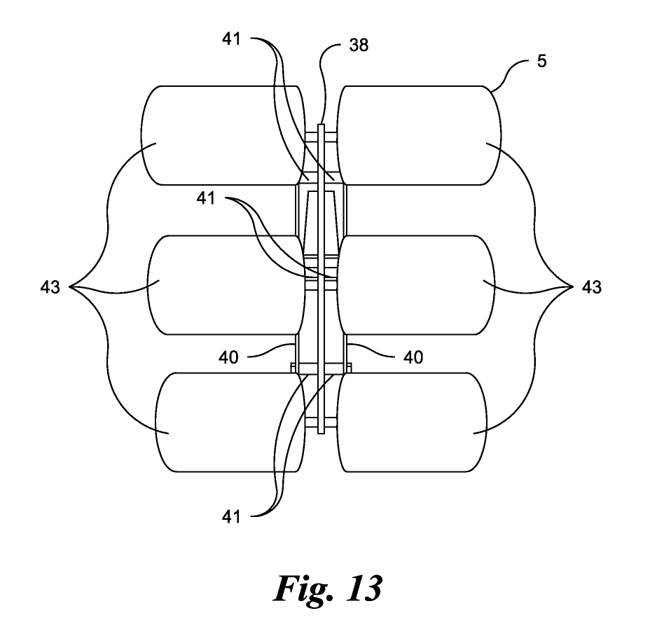

FIG. 13 is top view of a roller assembly illustrating attachment of the rollers to a flange disposed between a pair of plates and attached thereto via bolts and bushings in accordance with an embodiment of the invention.

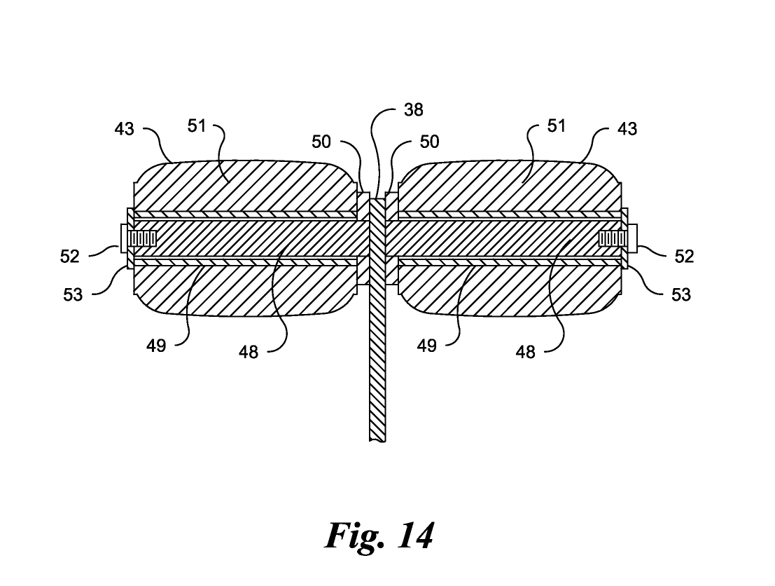

FIG. 14 is a cross-sectional view of a roller assembly illustrating the paired arrangement and attachment of rollers to a central flange in accordance with an embodiment of the invention.

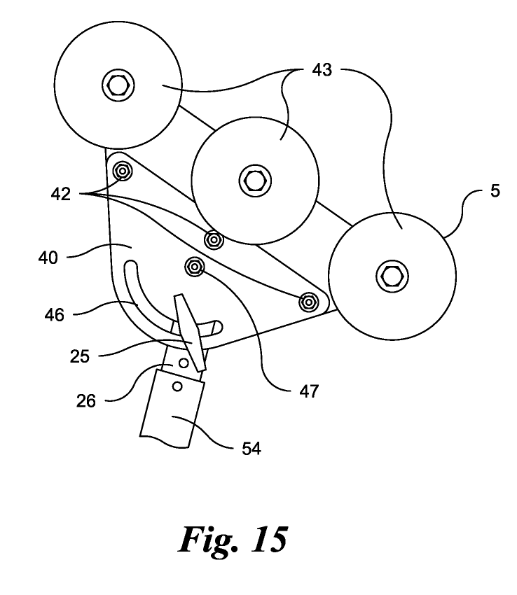

FIG. 15 is a left side view of a roller assembly illustrating attachment to an inner tube so as to allow for angular adjustability of the rollers with respect to the inner tube via a circular slot disposed along the outer plate in accordance with an embodiment of the invention.

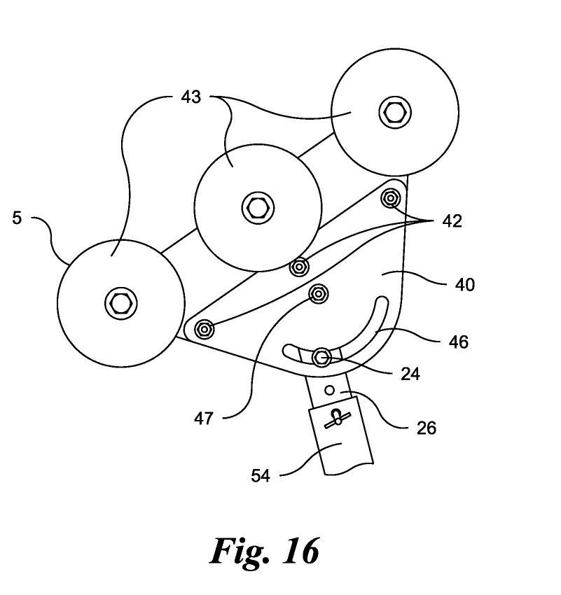

FIG. 16 is a right side view of a roller assembly illustrating attachment to an inner tube so as to allow for angular adjustability of the rollers with respect to the inner tube via a circular slot disposed along the outer plate in accordance with an embodiment of the invention.

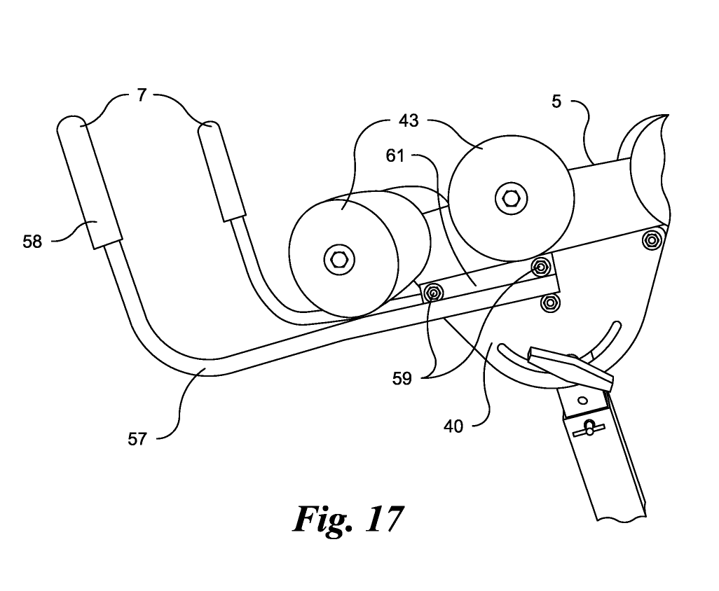

FIG. 17 is an enlarged view of one end of the apparatus illustrating attachment of a safety catch or stop or optional hand bars to the sides of a roller assembly in accordance with an embodiment of the invention.

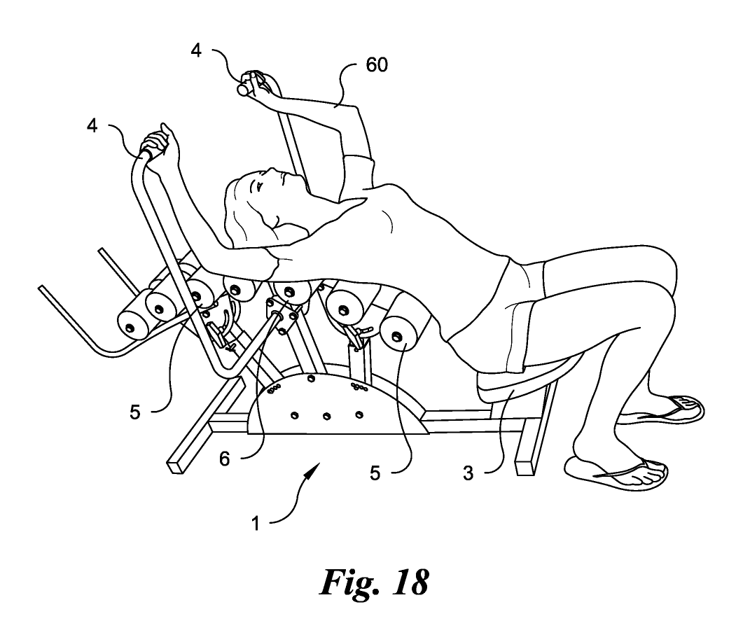

FIG. 18 is a perspective view of the apparatus illustrating a user resting on the seat with back contacting a roller assembly, neck contacting the center roller assembly, and hands grasping the hand bars.

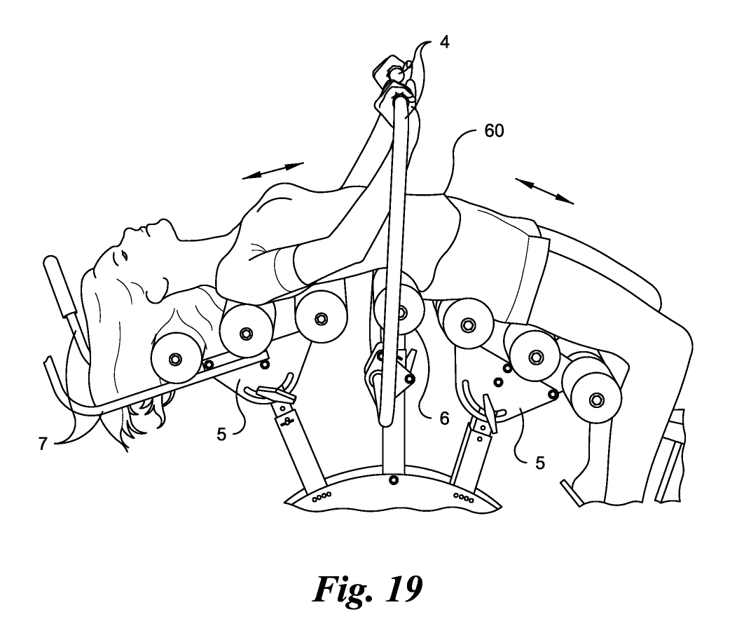

FIG. 19 is a side view of the apparatus illustrating position of a user during use so that the upper back extends past the center roller assembly and contacts the second roller assembly, the lower back contacts the center roller assembly, and legs contact the first roller assembly.

### DETAILED DESCRIPTION OF THE INVENTION

Reference will now be made in detail to several preferred embodiments of the invention that are illustrated in the accompanying drawings. Wherever possible, same or similar reference numerals are used in the drawings and the description to refer to the same or like parts. The drawings are not to precise scale. While fasteners and bolts are referred to throughout the description with and without washers and other hardware, it is understood that washers and lock washers could be applicable even when not specifically identified. Components are preferred to be composed of metal or other materials with comparable properties, unless otherwise noted.

Referring now to FIGS. 1-2, the apparatus 1 includes a seat 3, a roller assembly 5, a center roller assembly 6, and another roller assembly 5 attached to a base element 2 in the order described. A pair of hand bars 4 is attached to the center roller assembly 6 so as to extend away from the base element 2. The roller assemblies 5 and center roller assembly 6 are adjustable with respect to the base element 2 and secured thereto prior to use. However, it might be advantageous in some embodiments for the roller assemblies 5 to be rotatable or movable rather than fixed to the base element 2 during use to dynamically adjust to the spinal column for improved stimulation thereof.

The base element 2 includes a horizontal member 9 attached to a pair of stabilizer arms 10. Horizontal member 9 and stabilizer arms 10 could be bar-shaped elements of hollow or solid construction which are of generally linear extent, preferably with a square or rectangular cross section. The stabilizer arms 10 are mechanically fastened to, welded to, or molded onto each of the horizontal members 9 so as to form a generally I-shape structure. While the length of each stabilizer arm 10 is design dependent, it is preferred to be sufficient long so as to prevent the apparatus 1 from tipping over during use. For example, seventeen inch long stabilizer arms 10 were sufficient for an apparatus 1 constructed primarily of hollow steel components with a horizontal member 9 approximately forty-seven inches long.

The hand bars 4 are each comprised of a u-shaped bar 19 having a grip 20 attached at one end thereof. The u-shaped bar 19 is an element having a generally circular cross section, preferably hollow to minimize weight. The grip 20 could be comprised of a cup-shaped plastic or compressible material with outer surface shaped to approximate a hand. The grip 20 could be either press fit onto one end of the u-shaped bar 19 or adhesively attached thereto. The hand bars 4 are secured to the apparatus 1 prior to use. However, the hand bars 4 could freely move in some embodiments to improve the stimulative benefits of the apparatus 1 based on the experience level of the user.

In some embodiments, a second pair of hand bars 7 could be disposed at and extending from one end of the apparatus 1. The hand bars 7 also function as a stop to prevent a user from sliding off the apparatus 1 during use.

Referring now to FIGS. 3 and 4, the seat 3 is shown attached to the horizontal member 9 and stabilizer arm 10 at one end of the base element 2. While a variety of fixed and adjustable attachment arrangements are possible, the seat 3 could be mechanically secured to a vertical member 8 which is mechanically fastened or welded to the base element 2. The other end of the vertical member 8 could be mechanically fastened or welded onto a plate 21. The seat 2 could include a compressible fill 65 surrounded by a cover 67 and having a rigid planar element 66 along one side. The fill 65 could be composed of compressible foam, polymer, or elastomer. The cover 67 could be a man-made or natural material, examples being vinyl or leather, respectively. The planar element 66 could be composed of wood or plywood. The planar element 66 could be mechanically fastened to the plate 21 via fasteners 22, one example being screws.

Referring now to FIG. 5, a hollow stabilizer arm 10 is shown including an adjustable non-swivel guide 63 attached to one wall 68 thereof. The adjustable non-swivel guide 63 could pass through a like-size hole 62 which is threaded to allow for adjusts to the degree of extension of the guide 63 from the wall 68. Two or more such guides 63 could reside along each stabilizer arm 10 so as to facilitate leveling of the apparatus 1 with respect to a support surface 69. In some embodiments, it might be preferred to include a non-adjustable guide 63 which grips the support surface 69.

Referring now to FIGS. 6 and 7, a pair of roller assemblies 5 is shown disposed about a center roller assembly 6 with a pair of hand bars 4. Each roller assembly 5 includes an extendable arm 54 which is secured at one end to a center element 11 along the base element 2. The center roller assembly 6 also includes a second extendable arm 55 which is secured at one end to the center element 11. Each extendable arm 54 and second extendable arm 55 could include an outer tube 12 and an inner tube 26. The inner tube 26 could reside within a cavity 17 of the outer tube 12 and be slidable therein so as to be movable in a telescoping or extendable arrangement. The cross section of the inner tube 12 and outer tube 26 could be either square or rectangular, however other shapes are possible. In preferred embodiments, the inner tube 12 is longer than the outer tube 26.

The center element 11 could include a pair of parallel plates 15, each having the general shape of a half-circle, which are welded or otherwise mechanically fastened about and to the horizontal member 9. A bolt 13 could pass through both plates 15 and the lower portion of each outer tube 12. The spacing between the plates 15 and compression by the bolt 13 should allow the outer tube 12 to freely rotate along the longitudinal axis of the horizontal member 9.

A plurality of adjustment holes 14 could pass through each plate 15 in a pair-wise arrangement adjacent to each outer tube 12. Each outer tube 12 would likewise include a pair of openings which would align with a pair of adjustments holes 14 along the plates 15 as the outer tube 12 is rotated with respect to the center element 11. As such, it is desired for the adjustment holes 14 to align with the openings of the outer tube 12 along a circular arc. A quick release pin 16 or other mechanical fastener could pass through a pair of aligned adjustment holes 14 and complementary openings along the outer tube 12 so as to fix each roller assembly 5 and/or center roller assembly 6 at a given angular orientation with respect to the base element 2. In some embodiments, it might be advantageous to have the center roller assembly 6 at a fixed angular orientation, preferably vertical, with respect to the base element 2. Accordingly, a second bolt 13 could pass through complimentary aligned holes along the plates 15 and outer tube 12 of the second extendable arm 55 so as to fix the second extendable arm 55 to the center element 11.

Referring now to FIGS. 8-10, the upper end of the inner tube 26 includes a vertically disposed flange 28 which is either welded or mechanically fastened to the inner tube 26. A pair of contoured rollers 29 is disposed about the flange 28 in a horizontal arrangement so as to freely rotate about an axis perpendicular to the flange 28. The contoured rollers 29 are concave shaped to generally compliment to curvature of a human back adjacent to the spinal column. The adjacent ends of the contoured rollers 29 are shaped to impart a lateral force onto each vertebra. The outer circumference of the contoured rollers 29 should extend beyond the flange 28. A plurality of pair-wise arranged holes 37 are disposed along the length of two sides of the inner tube 26. A pair-wise arrangement of two holes 39 is disposed at the upper end of the outer tube 12 along the same sides as the inner tube 26. The pair-wise set of holes 37 aligns with the holes 39 as the inner tube 26 slides up and down within the outer tube 12. A quick release pin 27 is inserted through the aligned holes 37, 39 so as to fix the length of the inner tube 26 which extends above the outer tube 12, thereby also fixing the length of the second extendable arm 55 and the height of the contoured rollers 29 with respect to the roller assemblies 5.

Referring now to FIG. 11, a pair of shafts 33 is either welded to or mechanically fastened to the flange 28 so as to extend from the flange 28 and inner tube 26 in a perpendicular arrangement. Each contoured roller 29 includes a cylinder-shaped bushing 35 having a flange 36 disposed at each end thereof and extending from the bushing 35 in a perpendicular arrangement. The bushing 35 is composed of a material, preferably a low-friction polymer, which freely rotates about the shaft 33 without binding. A padding 30, preferably a compressible and resilient foam, is disposed about the outer circumference of the bushing 35 between the flanges 36 extending from the ends of each bushing 35. The padding 30 could be fixed to the bushing 35 via an interference fit or adhesively bonded thereto. A bushing 35 is placed onto each shaft 33 so as to provide an arrangement whereby the bushing 35 freely rotating about the shaft 33. A washer 31 and bolt 32 could secure the contoured roller 29 onto each shaft 33.

Referring again to FIGS. 8-10, one end of each u-shaped bar 19 is either welded or mechanically fastened to a substantially triangular-shaped plate 18 in a perpendicular arrangement. Each plate 18 includes an opening adjacent to each corner of the plate 18. A pair of bolts 23 passes through the mutually aligned openings along one side of the plates 18 and tightened so that the plates 18 freely slide along the length of the outer tube 12. A third adjustable bolt 24 with knob 25 passes through the third mutually aligned openings along both plates 18 along a side of the outer tube 12 opposite of the bolts 23. The knob 25 is turned in one direction so as to press the plates 18 against the outer tube 12, locking the hand bars 4 thereto. The knob 25 is turned in the opposite direction so as to release the plates 18 from the outer tube 12, thereby allowing the hand bars 4 to move up and down along the outer tube 12.

Referring now to FIGS. 12-14, each roller assembly 5 includes a pair-wise arrangement of two or more rollers 43 attached to a structure at one end of an extendable arm 54. A center plate 38 is disposed between and attached to a pair of plates 40. The center plate 38 and plates 40 each include at least three openings. A bolt 42 is inserted through one opening along one plate 40, a cylinder-shaped bushing 41, one opening along the center plate 38, a cylinder-shaped bushing 41, and one opening along another plate 40 and secured thereto. Two or more bolts 42 are generally required to properly secure the outer plates 40 to the center plate 38, as described herein.

A pair-wise arrangement of shafts 48 is welded or mechanically fastened to the center plate 38 in a perpendicular arrangement. A roller 43 is placed onto and freely rotates about each shaft 48. Each roller 43 includes a cylinder-shaped bushing 49, preferably a low-friction polymer, having a padding 51 disposed about the outer circumference thereof. The padding 51 could be secured to the bushing 49 as otherwise provided herein. A mechanical stop 50 could reside between each roller 43 and the center plate 38. The mechanical stop 50 could be a washer-like element or step along the shaft 48, having an outer diameter less than that of the roller 43. This arrangement minimizes binding which might otherwise result when the rollers 43 directly contact the center plate 38. A bolt 52 with washer 53 could be threaded into a like-threaded cavity at the end of each shaft 33 to secure the rollers 43 thereto.

Referring now to FIGS. 12, 15, and 16, the extendable arm 54 is secured at one end between and to the plates 40. A bolt 47 is inserted through an opening along one plate 40, a pair of aligned openings in the inner tube 26, and an opening along the other plate 40 and secured thereto. This arrangement allows the extendable arm 54 to freely rotate about the bolt 47 with respect to the rollers 43, center plate 38, and plates 40. One or more low-friction washers 34, preferably composed of a polymer, could be placed along the bolt 47 between the plates 40 and inner tube 26 to prevent binding.

An adjustable bolt 24 with knob 25 is likewise attached to the inner tube 26 and plates 40 parallel to and offset from the bolt 47. The adjustable bolt 24 is inserted through an arcuate slot 46 disposed along one plate 40, a pair of aligned openings along the inner tube 26, and an arcuate slot 46 disposed long the other plate 40 and secured thereto. One or more low-friction washers 34, preferably composed of a polymer, could be placed along the adjustable bolt 24 between each plate 40 and the inner tube 26 to prevent binding. The knob 25 is turned in one direction so as to press the plates 40 against the inner tube 26 locking the plates 40, center plate 38 and rollers 43 thereto. The knob 25 is turned in the opposite direction so as to release the plates 40 from the inner tube 26, thereby allowing the plates 40, center plate 38, and rollers 43 to rotate about the bolt 47 with respect to the inner tube 26. Features and functionality of the extendable arm 54 with reference to the inner tube 12 and outer tube 26 are as described above for the second extendable arm 55.

Referring now to FIG. 17, some embodiments of the apparatus 1 could include a pair of secondary hand bars 7 attached to a roller assembly 5. Each hand bar 7 could include an L-shaped bar 57, preferably hollow with a circular cross section, and a flange 61 welded or otherwise mechanically attached along one end of the L-shaped bar 57. The flange 61 could include openings which align with openings along the plate 40, thus allowing the flange 61 to be mechanically attached to the plate 40 via a pair of bolts 59. The opposite end of the L-shaped bar 57 could include a sleeve-like grip 58 composed of a polymer or compressible foam. The grip-end of the L-shaped bar 57 should extend above the horizontal plane of the rollers 43 so as to facilitate use of the hand bars 7 and functionality thereof as a safety mechanism which prevents a user from sliding along the roller assembly 5 opposite of the seat 3 and off the apparatus 1.

Referring now to FIGS. 18 and 19, a user 60 is shown along an apparatus 1 configured so that the roller assemblies 5 are rotated at an angle from the vertical away from and at a height less than the center roller assembly 6. This arrangement opens and extends the vertebra thereby maximizing the stimulative benefits of the apparatus 1.

In FIG. 18 the user 60 is in the start position with posterior contacting the seat 3, back contacting one roller assembly 5, neck region contacting the center roller assembly 6, and hands grasping the hand bars 4. The user 60 slides up and onto the apparatus 1 by pulling on the hand grips 4 and pushing with her legs. As the user 60 slides over the first roller assembly 5, the back contacts the center roller assembly 6 so that the spinal column is disposed between the contoured rollers 29, which apply a force onto the spinal column transverse to its length. The applied force aligns and massages the vertebra along the spinal column.

As represented in FIG. 19, the user 60 slides over the contoured rollers 29 in a back and forth motion so as to align and massage the enter length of the spinal column. The user 60 could grasp the secondary hand bars 7 during a portion of the massage regiment. Otherwise, the hand bars 7 could act as a stop to prevent the user 60 from sliding too far past the second roller assembly 5.

The description above indicates that a great degree of flexibility is offered in terms of the invention. Although various embodiments have been described in considerable detail with reference to certain preferred versions thereof, other versions are possible. Therefore, the spirit and scope of the appended claims should not be limited to the description of the preferred versions contained herein.

What is claimed is:

1. An apparatus for massaging and aligning a spinal column comprising:
(a) a base element for supporting said apparatus along a support surface;
(b) a pair of roller assemblies, each said roller assembly including an extendable arm and a plurality of rollers, said extendable arm attached at one end to said base element so as to allow angular adjustment to said roller assembly with respect to said base element, said extendable arm attached at another end to said rollers so as to allow angular adjustment of said rollers with respect to said extendable arm;
(c) a center roller assembly disposed between said pair of roller assemblies, said center roller assembly including a second extendable arm and a pair of contoured rollers, said second extendable arm attached at one end to said base element and at another end to said contoured rollers;
(d) a pair of hand bars attached to said second extendable arm, said hand bars slidable along said second extendable arm so as to adjust the height of said bars; and
(e) a seat disposed at one end of said apparatus.

2. The apparatus of claim 1, wherein said center roller assembly is attached to said base element in a fixed arrangement.

3. The apparatus of claim 1, wherein said center roller assembly is attached to said base element so as to allow angular adjustment of said center roller assembly with respect to said second extendable arm.

4. The apparatus of claim 1, further comprising:
(f) a pair of second hand bars attached to one of said roller assemblies.

5. The apparatus of claim 1, wherein said extendable arms and said second extendable arm each includes an inner tube disposed within and slidable with respect to an outer tube.

6. The apparatus of claim 5, wherein said inner tube and said outer tube each includes a plurality of pair-wise arranged holes, said extendable arm fixed at a length via a pin which passes through one of said plurality of pair-wise arranged holes along each of said inner tube and said outer tube.

6. The apparatus of claim 1, wherein said rollers are disposed in a pair-wise arrangement along said roller assembly.

7. The apparatus of claim 1, wherein said extendable arms are disposed between a pair of plates along said base element, said plates having a plurality of holes and each said extendable arm has a pair of aligned holes which aligns with one of said plurality of holes along each said plate, said extendable arm fixed to said plates via a pin which passes through two of said plurality of holes and said pair of aligned holes.

8. The apparatus of claim 1, wherein said second extendable arm is disposed between a pair of plates attached to said base element, said plates having a plurality of holes and each said extendable arm has a pair of aligned holes which align with one of said plurality of holes along each said plate, said extendable arm fixed to said plates via a pin which passes through two of said plurality of holes and said pair of aligned holes.

9. The apparatus of claim 1, wherein each said roller assembly includes a pair of plates disposed about and contacting said extendable arm, each said plate has a slot, an adjustable fastener passes through said slots along said pair of plates, said roller assembly rotatable with respect to said extendable arm when said adjustable fastener is loosened and fixed when said adjustable fastener is tightened.

10. The apparatus of claim 1, wherein said pair of hand bars includes a pair of plates disposed about said extendable arm, said pair of plates slidable along said second extendable arm, said pair of plates compressed onto and fixed to said second extendable arm via an adjustable fastener.

11. The apparatus of claim 10, wherein said pair of hand bars are allowed to move freely depending on the experience of the user.

12. The apparatus of claim 1, wherein said contoured rollers are shaped to align vertebrae along said spinal column.

13. The apparatus of claim 1, wherein at least one said roller assembly is offset from said center roller assembly so as to curve said spinal column.
